(19) United States
(12) Patent Application Publication
(10) Pub. No.: US 2017/0013608 A1
(43) Pub. Date: Jan. 12, 2017

(54) PUCCH RESOURCE ALLOCATION METHOD, NETWORK SIDE DEVICE AND COMMUNICATIONS SYSTEM

(71) Applicant: ZTE CORPORATION, Shenzhen, Guangdong (CN)

(72) Inventors: Xuhui DU, Guangdong (CN); Ning LI, Guangdong (CN)

(21) Appl. No.: 15/105,810

(22) PCT Filed: Jun. 10, 2014
(86) PCT No.: PCT/CN2014/079626

§ 371 Date: Jun. 17, 2016

(30) Foreign Application Priority Data
Dec. 18, 2013 (CN) 201310700359.5

(51) Int. Cl. H04W 72/04; H04W 72/10

(52) U.S. Cl. CPC H04W 72/0413; H04W 72/10

(57) ABSTRACT

Embodiments of the present disclosure disclose a Physical Uplink Control Channel (PUCCH) resource allocation method, a network side device and a communications system, wherein the method includes: when a new user equipment (UE) access a cell in a case that idle PUCCH resources of the cell are insufficient or all PUCCH resources of the cell are fully occupied, determining a preempted UE among UEs already accessing the cell; allocating PUCCH resources of the preempted UE to the new UE, reconfiguring the preempted UE and notifying the preempted UE to release the PUCCH resources.

### TECHNICAL FIELD

The present disclosure relates to communications technologies, and more particularly, to a Physical Uplink Control Channel (PUCCH) resource allocation method, a network side device and a communications system.

### BACKGROUND

In an existing communications system, PUCCH resources are limited, however, there are many demands for transmitting by utilizing PUCCH resources. For example, UE may transmit, through PUCCH, Scheduling Request (SR) for requesting Uplink Shared Channel (USCH) resources to transmit uplink data and CQI for indicating Physical Downlink Shared Channel (PDSCH) quality. However, as the number of users increases, PUCCH resources will run out, so that PUCCH resources are unable to be allocated to some UEs.

In a process of implementing the present disclosure, inventors that in technical solutions of the existing art, in a case where PUCCH resources are limited, the SR, for example, may be transmitted through other resources such as Physical Random Access Channel (PRACH). However, a transmission effect by utilizing other resources is inferior to a transmission effect by utilizing PUCCH. Meanwhile, in existing technical solutions, user priorities are not considered in resource allocation, and resources are allocated according to access sequence instead. That is, resources are allocated to UEs earlier accessing in priority, and when resources in a resource pool run out, no resource will be allocated to UEs later accessing even though these UEs which later accesses have higher priorities. Uplink and downlink traffics of the user may be affected in a case that there are not enough PUCCH resources for transmitting some important requests or information such as SR and CQI, which is disadvantageous to perception of a high-priority user.

### SUMMERY

To solve above problems, embodiments of the present disclosure provide a PUCCH resource allocation method, a network side device and a communications system.

Embodiments of the present disclosure provide a PUCCH resource allocation method, which includes:

when a new UE accesses a cell in case that idle PUCCH resources of the cell are insufficient or all PUCCH resources of the cell are fully occupied, determining a preempted UE among UEs already accessing the cell; allocating the PUCCH resources of the preempted UE to the new UE, reconfiguring the preempted UE and notifying the preempted UE to release PUCCH resources.

Embodiments of the present disclosure provide a network side device, which includes:

a judging unit, configured to judge, when a new UE accesses a cell, whether idle PUCCH resources of the cell are allocated to the new UE;

a determining unit, configured to determine a preempted UE among UEs already accessing the cell according to information transmitted by the judging unit; and

a resource allocating unit, configured to allocate PUCCH resources of the preempted UE to the new UE according to information transmitted by the determining unit, and reconfigure the preempted UE and notify the preempted UE to release the PUCCH resources.

Embodiments of the present disclosure provide a communications system, where the system includes: at least one UE and the foregoing network side device.

According to at least one of the foregoing technical solutions, when PUCCH resources are insufficient or run out, to a new UE, PUCCH resources of UEs already accessing the cell are allocated to the new UE by setting up a preemption process, thereby overcoming a problem that resources are unable to be allocated to the new UE when the new UE has a higher priority, and improving a system optimization degree on the whole by allocating resources by weighing a priority of each UE and other states on a whole system.

### BRIEF DESCRIPTION OF DRAWINGS

FIG. 1 is a schematic diagram of a method according to Embodiment I of the present disclosure;

FIG. 2 is a schematic diagram of a method according to Embodiment II of the present disclosure;

FIG. 3 is a schematic diagram of a method according to Embodiment III of the present disclosure;

FIG. 4 is a schematic diagram of a device according to Embodiment IV of the present disclosure;

FIG. 5 is a schematic diagram of a device according to Embodiment V of the present disclosure; and

FIG. 6 is a schematic diagram of a system according to Embodiment VI of the present disclosure.

### DETAILED DESCRIPTION

The following will clearly and completely describe the technical solutions in embodiments of the present disclosure with reference to the accompanying drawings of embodiments of the present disclosure. Apparently, described embodiments are some but not all of embodiments of the present disclosure. All other embodiments obtained by a person of ordinary skill in the art based on the embodiments of the present disclosure without creative efforts shall fall within the protection scope of the present disclosure.

### Embodiment I

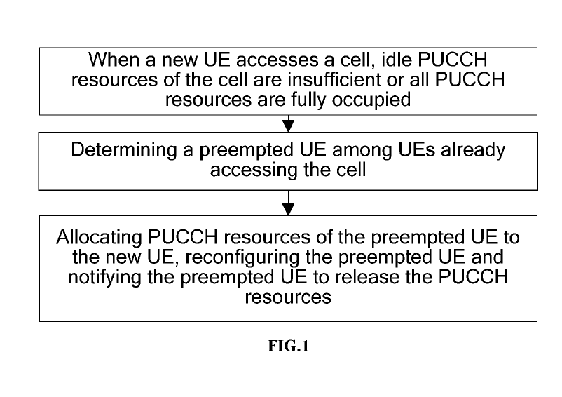

FIG. 1 shows a PUCCH resource allocation method according to Embodiment I of the present disclosure, and this embodiment specifically includes following steps.

When a new UE requests to accesses a network side device, idle PUCCH resources of a cell are insufficient or all PUCCH resources of the cell are fully occupied, and a system is unable to allocate PUCCH resources to anew UE, the network side device determines a preempted UE among UEs already accessing the cell according to information of the UE. PUCCH resources of the preempted UE are allocated to the new UE; the preempted UE is reconfigured and notified to release corresponding PUCCH resources.

Thus, by reasonably determining the preempted UE, optimal allocation of priority resources is implemented and a whole optimization degree of the system is improved.

### Embodiment II

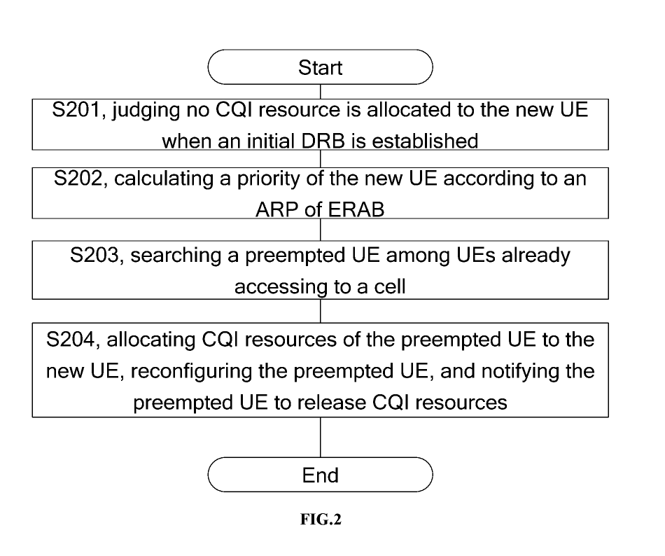

FIG. 2 shows a PUCCH resource allocation method according to Embodiment II of the present disclosure, and this embodiment is described by taking allocation of PUCCH CQI resources as an example.

When an RRC is established for the new UE, no resource is allocated to the new UE if the cell has no idle PUCCH CQI resource, and it is proceeded with S201 after the RRC is established.

In S201, it is judged that no CQI resource is allocated to the new UE when an initial DRB is established for the new UE.

In S202, a priority of the new UE is determined according to an Address Resolution Protocol (ARP) of evolved Radio Access Bearer (eRAB) requested by the new UE.

In S202, those skilled in the art may understand that the priority of the new UE is determined by using routine technique, according to an ARP of eRAB requested by the new UE;

In S203, a preempted UE among UEs already accessing the cell is searched;

from the UEs already accessing the cell, search a UE meeting one of following conditions as the preempted UE (UE meeting Condition 1 is preferentially preempted):

Condition 1: UE conducting no service at an uplink and a downlink within a set period of time (the time may be configured at eNodeB), allocated with PUCCH resources and having a lowest priority; or

Condition 2: UE having a lowest priority among all UEs lower than a currently-accessed UE in priority and allocated with PUCCH resources.

In S203, factors, such as a current degree of activity and a priority of UE, are synthetically considered. Those skilled in the art should understand that priorities of all UEs shall be obtained in or before S203, and the priorities of UEs already accessing a network side device may have been prestored in the network side device, or may be obtained by calculation in accordance with a manner of S202.

In S204, Channel Quality Indicator (CQI) resources of the preempted UE are allocated to the new UE through a reconfiguration message, resources of the preempted UE are reconfigured, and the preempted UE is notified to release its own CQI resources through the reconfiguration message.

### Embodiment III

FIG. 3 shows a PUCCH resource allocation method according to Embodiment III of the present disclosure; this embodiment is different from Embodiment II in including a case of failure of PUCCH resource allocation and including two cases of PUCCH SR resource allocation and PUCCH CQI and PUCCH SR resources allocation.

Specifically, during an initial DRB, it is judged whether PUCCH resources are allocated to the new UE;

here, a specific implementation may be: it is judged whether CQI resources are allocated, whether SR resources are allocated, or whether CQI resources and SR resources are allocated; it is proceeded with a next step if a judgment result is no; if a judgment result is yes, corresponding PUCCH resources are normally allocated to the new UE, and the process ends.

The priority of the new UE is calculated according to an ARP of the new UE.

When a most suitable preempted UE is searched in the cell, it is proceeded with a next step if a corresponding preempted UE is found; or resource allocation process ends if no preempted UE is found according to a preset preemption condition.

CQI and/or SR resources of the preempted UE are allocated to a preemption UE, the preempted UE is reconfigured, and the preempted UE is notified to release the CQI and/or SR resources.

If no PUCCH resource is allocated to the new UE, when an initial DRB is established and UE is reconfigured, no PUCCH resource is allocated to the new UE.

### Embodiment IV

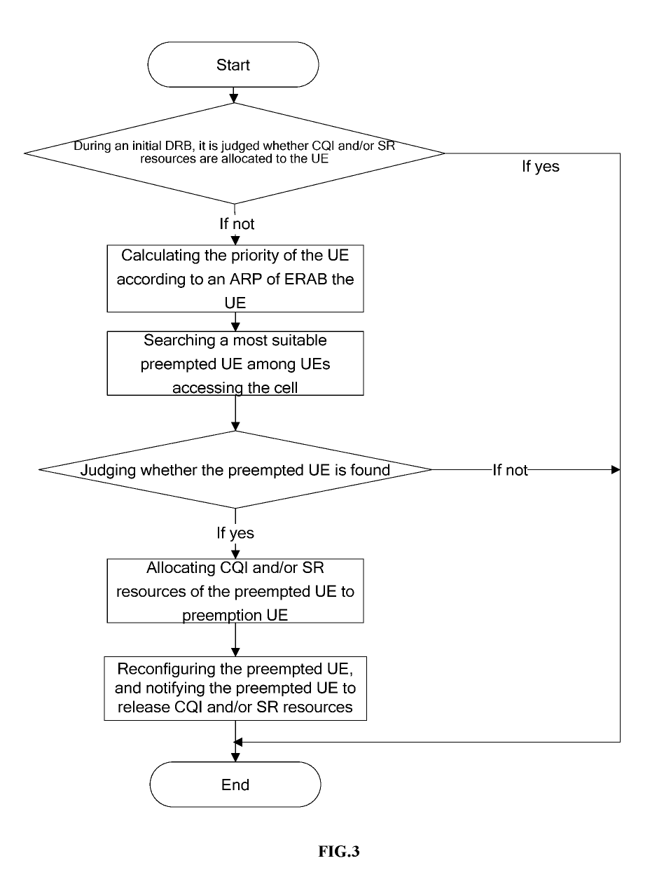

FIG. 4 shows a PUCCH resource allocation network side device according to Embodiment

IV of the present disclosure, and the device includes:

a judging unit 41, configured to judge, when a new UE accesses a cell, whether idle PUCCH resources of the cell are allocated to the new UE;

a determining unit 42, configured to determine a preempted UE among UEs already accessing the cell according to information transmitted by the judging unit; and

a resource allocating unit 43, configured to allocate PUCCH resources of the preempted UE to the new UE according to information transmitted by the determining unit, and reconfigure the preempted UE and notify the preempted UE to release the PUCCH resources.

Persons skilled in the art may understand that the network side device at least may be a base station.

The judging unit, the determining unit and the resource allocating unit may be implemented by hardware such as a DSP or a CPU.

### Embodiment V

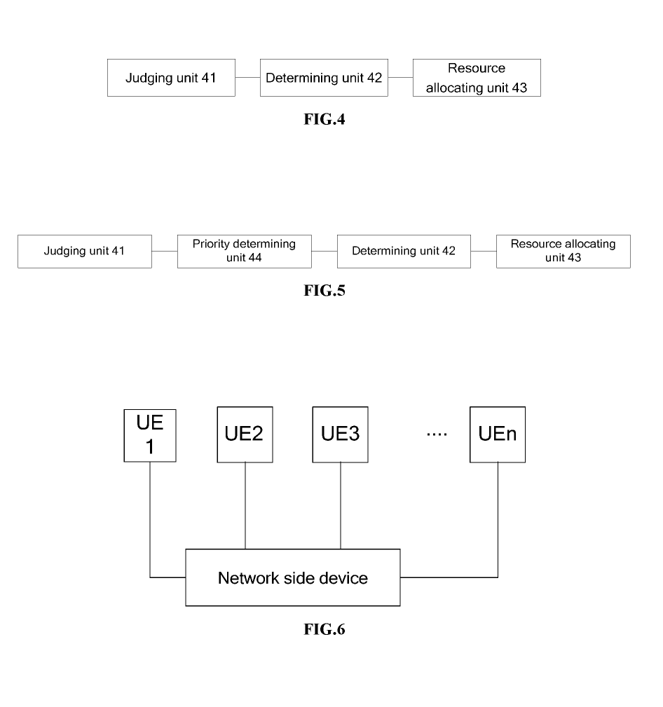

FIG. 5 shows a PUCCH resource allocation network side device according to Embodiment V of the present disclosure, and the device includes:

a judging unit 41, configured to judge, when a new UE accesses a cell, whether idle PUCCH resources of the cell are allocated to the new UE;

a determining unit 42, configured to determine a preempted UE among UEs already accessing the cell according to information transmitted by the judging unit; and

a resource allocating unit 43, configured to allocate PUCCH resources of the preempted UE to the new UE according to information transmitted by the determining unit, and reconfigure the preempted UE and notify the preempted UE to release the PUCCH resources.

This embodiment is different from Embodiment IV in that a priority determining unit 44 is added.

The priority determining unit 44 is configured to calculate a priority of UE according to an ARP of eRab of the UE, and provide information to the determining unit. The determining unit processes for determining the preempted UE by synthesizing factors such as a degree of activity and a priority of the UE.

More specifically, the determining unit is configured to determine a UE conducting no service at an uplink and a downlink within a set time, allocated with PUCCH resources and having a lowest priority to be the preempted UE, or determine a UE having a lowest priority among all UEs lower than a currently-accessed UE in priority and allocated with PUCCH resources to be the preempted UE.

### Embodiment VI

FIG. 6 shows a communications system according to Embodiment VI of the present disclosure, and the system includes at least one UE and a network side device, wherein the network side device is configured to allocate PUCCH resources to UE requested to access, and the device is obtained according to at least one of technical solutions in embodiments of the network side device of the present disclosure.

The abovementioned embodiments are merely preferred embodiments of the present disclosure. It shall be pointed out that to those of ordinary skill in the art, various improvements and embellishments may be made without departing from the principle of the present disclosure, and these improvements and embellishments are also deemed to be within the scope of protection of the present disclosure.

1. A Physical Uplink Control Channel PUCCH resource allocation method, comprising:
when a new user equipment UE accesses a cell in a case that idle PUCCH resources of the cell are insufficient or all PUCCH resources of the cell are fully occupied, determining a preempted UE among UEs already accessing the cell;
allocating PUCCH resources of the preempted UE to the new UE, reconfiguring resources of the preempted UE and notifying the preempted UE to release the PUCCH resources.

2. The allocation method according to claim 1, wherein determining the preempted UE comprises:
determining a UE conducting no service at an uplink and a downlink within a set time, allocated with PUCCH resources, and having a lowest priority to be the preempted UE; or
determining a UE having a lowest priority among all UEs lower than the new UE in priority and allocated with PUCCH resources to be the preempted UE.

3. The allocation method according to claim 1, before determining the preempted UE, further comprising:
obtaining a priority of the UE.

4. The allocation method according to claim 3, wherein obtaining the priority of the UE comprises:
obtaining the priority by calculating according to a parameter of an Address Resolution Protocol ARP of Evolved Radio Access Bearer ERAB of the UE.

5. The allocation method according to claim 1, wherein the PUCCH resources comprises:
resources for transmitting PUCCH Channel Quality Indicator CQI and/or PUCCH Scheduling Request SR.

6. A network side device, comprising:
a judging unit, configured to judge, when a new UE accesses a cell, whether idle PUCCH resources of the cell are allocated to the new UE;
a determining unit, configured to determine a preempted UE among UEs already accessing the cell according to information transmitted by the judging unit; and
a resource allocating unit, configured to allocate PUCCH resources of the preempted UE to the new UE according to information transmitted by the determining unit, and reconfigure resources of the preempted UE and notify the preempted UE to release the PUCCH resources.

7. The network side device according to claim 6, wherein the determining unit is configured to
determine a UE conducting no service at an uplink and a downlink within a set time, allocated with PUCCH resources and having a lowest priority to be the preempted UE; or
determine a UE having a lowest priority among all UEs lower than the new UE in priority and allocated with PUCCH resources to be the preempted UE.

8. The network side device according to claim 6, further comprising:
a priority determining unit, configured to calculate a priority of the new UE according to a parameter of an ARP of ERAB of the new UE, and provide information to the determining unit.

9. The network side device according to claim 6, wherein
the judging unit is configured to judge, when the new UE accesses the cell, whether resources for transmitting PUCCH CQI and/or PUCCH SR are allocated to the new UE.

10. (canceled)

11. A non-transitory computer storage medium storing instructions which, when executed by a processor, cause the processor to perform a method comprising:
when a new user equipment UE accesses a cell in a case that idle PUCCH resources of the cell are insufficient or all PUCCH resources of the cell are fully occupied, determining a preempted UE among UEs already accessing the cell;
allocating PUCCH resources of the preempted UE to the new UE, reconfiguring resources of the preempted UE and notifying the preempted UE to release the PUCCH resources.

12. The non-transitory computer storage medium according to claim 11, wherein
determining the preempted UE comprises:
determining a UE conducting no service at an uplink and a downlink within a set time, allocated with PUCCH resources, and having a lowest priority to be the preempted UE; or
determining a UE having a lowest priority among all UEs lower than the new UE in priority and allocated with PUCCH resources to be the preempted UE.

13. The non-transitory computer storage medium according to claim 11, wherein
before determining the preempted UE, the method further comprises:
obtaining a priority of the new UE.

14. The non-transitory computer storage medium according to claim 13, wherein
before determining the preempted UE, the method comprises:
obtaining a priority of the new UE.

15. The non-transitory computer storage medium according to claim 11, wherein
obtaining the priority of the new UE comprises:
obtaining the priority by calculating according to a parameter of an Address Resolution Protocol ARP of Evolved Radio Access Bearer ERAB of the new UE.

16. The non-transitory computer storage medium according to claim 12, wherein
the PUCCH resources comprises:
resources for transmitting PUCCH Channel Quality Indicator CQI and/or PUCCH Scheduling Request SR.

17. The allocation method according to claim 2, before determining the preempted UE, the method further comprises:
obtaining a priority of the new UE.
